(19) United States
(12) Patent Application Publication
(10) Pub. No.: US 2019/0271806 A1
(43) Pub. Date: Sep. 5, 2019

(54) DISPLAYS

(71) Applicant: FlexEnable Limited, Cambridge (GB)

(72) Inventor: Charlotte Harrison, Cambridge (GB)

(21) Appl. No.: 16/286,790

(22) Filed: Feb. 27, 2019

(30) Foreign Application Priority Data
Mar. 5, 2018 (GB) 1803489.2

(51) Int. Cl. F21V 8/00; G02F 1/1333

(52) U.S. Cl. CPC G02B 6/0053; G02F 1/133305; G02B 6/0036

(57) ABSTRACT

A display for mounting on a curved surface includes a display stack comprising a substrate to conform to a curved surface; a pixelated LCD (Liquid Crystal Display) display medium on the substrate; and a back light to illuminate the LCD display medium. The display stack also comprises a brightness enhancing film between the back light and the LCD display medium. The brightness enhancing film comprises a plurality of prisms to increase the brightness of light from the back light in a viewing direction. Shapes of the prisms change with lateral position on the display, to compensate for a change in viewing angle with lateral position on the display with respect to a curved surface of the display when the display is mounted on a curved surface.

### RELATED APPLICATIONS

The present invention is a U.S. Non-provisional application, claiming priority to Serial No. UK 1803489.2, Filed on 5 Mar. 2018 the entirety of which is incorporated herein by reference.

### FIELD OF THE INVENTION

The invention generally relates to flexible/curved displays.

### BACKGROUND TO THE INVENTION

There are many applications for curved displays and for displays which are flexible so that they may be conformed to a curved surface. These include conforming a display to the curved interior surface of a vehicle for displaying information to the driver and/or one or more passengers; and consumer electronic devices (CEDs) such as mobile phones, tablets, televisions and other devices with display screens.

Depending upon the application there may be a need to restrict the viewing angle of a curved display, for example for privacy or so that the driver of a vehicle, or a passenger, is not distracted. It may also be desirable to provide a bright, uniform display for a particular viewing direction, which may impose different but related requirements.

### SUMMARY OF THE INVENTION

The invention is set out in the independent claims. In one aspect a display for mounting on a curved surface includes a display stack comprising a substrate to conform to a curved surface; a pixelated LCD (Liquid Crystal Display) display medium on the substrate; and a back light to illuminate the LCD display medium. The display stack also comprises a brightness enhancing film between the back light and the LCD display medium. The brightness enhancing film comprises a plurality of prisms to increase the brightness of light from the back light in a viewing direction. Shapes of the prisms change with lateral position on the display, to compensate for a change in viewing angle with lateral position on the display with respect to a curved surface of the display when the display is mounted on a curved surface.

Examples of such a display are able to restrict the viewing angle of a flexible or curved display when, for example, it is mounted on a curved surface, and may also enhance the brightness of the display when viewed from a range of angles.

A prismatic brightness enhancing films may be used to increase the brightness of a display. Such a film may comprise a regular or random array of 3D prisms, with a polyhedral base and generally triangular faces; or it may comprise linear structures with a generally triangular cross-section; thus the structures may define a 2D or 1D pattern. Where the film comprises linear structures two films may be employed, one after the other in an optical path, with the linear structures at right angles to one another to provide an overall 2D pattern. A 3D prism may typically having a base dimension of between 20 μm and 200 μm; and may have an apex angle in the range 45-135°. Points or edges of the prisms may be sharp-pointed or rounded. The 2D cross-section of a linear structure may have similar dimensions. The film may be fabricated from, for example, polyester or polycarbonate, and the film or films may have a thickness of order 20-1000 μm

In broad terms such a film operates to concentrate light, for example from an LCD backlight, into a viewing cone. Light passing through the film is refracted at the surfaces of the prisms. Beyond a certain angle light is internally reflected and recycled, for example via a back reflector of the backlight or other recycling structure; or may exit and re-enter the surface of an adjacent prism. Thus light may be recycled until it exits via the viewing cone. The detailed optical behaviour is complex but may be modelled with optical design software such as Zemax™. In an LCD display the film may be located between the backlight and display medium.

For a curved display the local viewing angle, that is the angle between a direction from which the display viewed and the surface of the display (or a normal to the surface of the display) changes with lateral position on the display. In some implementations therefore the prisms are angled to compensate for this change in viewing direction.

A display may be configured to fit a curved surface. It may be fabricated as a curved display or it may be fabricated as a flexible display configured for a surface of a particular curvature, that is it may be optimised for viewing when mounted on the surface for which it is designed. The curvature may be curvature in one or two dimensions.

A prism direction may be defined by a line (in the case of a 3D prism) or a plane (in the case of a 2D triangular extrusion prismatic shape) from a location at the centre of a base of the prism to the apex of the prism. The prisms may be angled to compensate for local changes in viewing direction when the display is curved, or mounted on a curved surface, by arranging for the prism direction to correspond with the viewing direction at each point on or local region of the display surface.

Such an arrangement may be optimised, and for example to configure the flexible/curved display for a particular combination of surface, viewing direction and viewing cone, using optical design software such as Zemax™.

The brightness enhancing film may be located between a diffuser for the backlight and the LCD display medium. Alternatively the brightness enhancing film may be located in front of the display medium, for example before or after a polarising layer of the LCD display.

Whilst some examples of the display employ prisms, in other implementations these may be replaced by lenslets, for example of a lenticular array. In this case the lenslets may be distorted in a similar manner to that previously described, for example so that a direction the centre of the base to the apex of each lens is aligned along the viewing direction. More generally the lenslets may appropriately direct the light so as to preferentially direct the light from the display into a viewing cone or similar desired viewing region.

In another aspect there is provided a method of displaying information over a limited viewing angle using a curved display, the method comprising providing a brightness enhancing film between a back light for the display and an LCD display medium of the display, the brightness enhancing film comprising a plurality of prisms to increase the brightness of light from the back light in a viewing direction; and compensating for a change in viewing angle with respect to lateral position on the curved display by gradually distorting shapes of the prisms with lateral position on the curved display.

Further aspects of the method may be as previously described with reference to the display.

The method may comprise displaying information on a curved surface such as a curved surface inside a vehicle, for example a pillar of the vehicle; or on a curved surface of a consumer electronic device.

A vehicle may be provided with a camera to capture an image of the external environment and part or all of the captured image may then be reproduced on the curved display to increase visibility for the driver. This may give the impression that a part of the vehicle, such as an A-pillar, is partially or wholly transparent.

### BRIEF DESCRIPTION OF THE DRAWINGS

Embodiments of the invention will be described, by way of example, with reference to the accompanying drawings, in which:

FIGS. 1a and 1b show example display stacks; and

FIG. 2 shows a cross-sectional schematic view of a curved display incorporating a brightness enhancing film.

### DETAILED DESCRIPTION OF THE DRAWINGS

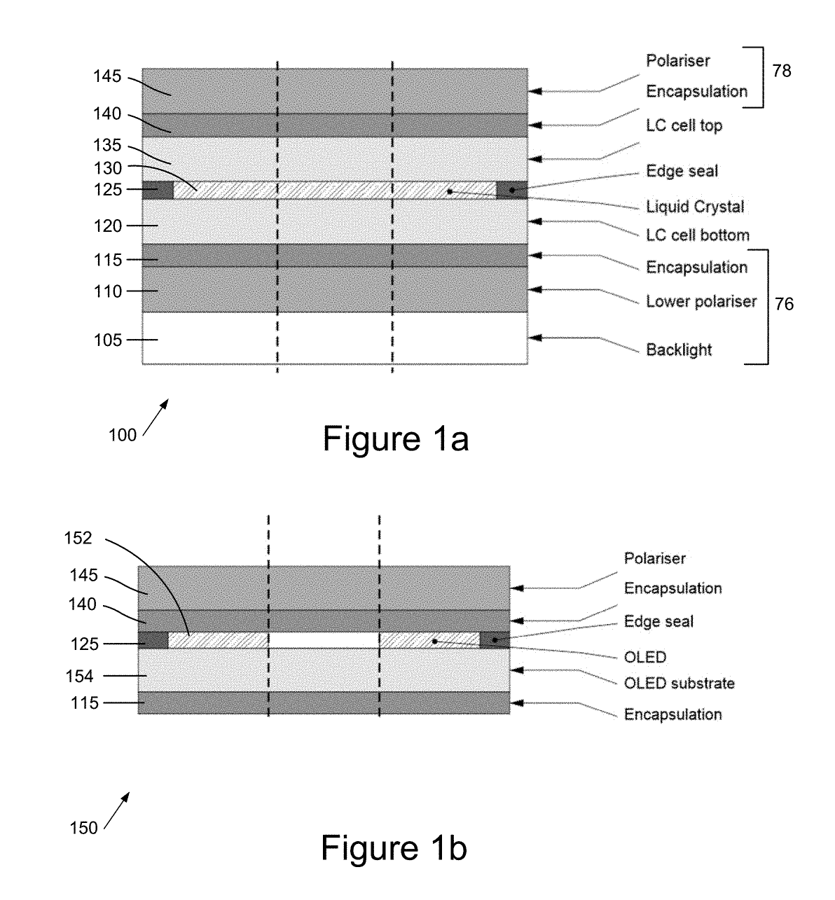

FIG. 1a illustrates a schematic cross-sectional view of an example display stack 100 of a liquid crystal display, which may be an OLCD (Organic LCD) display, where the TFTs are organic. In this example display stack the liquid crystal (LC) material 130 is disposed between a bottom (or first) encapsulation layer 115 and a top (or second) encapsulation layer 140. The LC material 130 is sandwiched by a LC cell top layer 135 and a LC cell bottom layer 120. An edge seal 125 is provided on both sides of the LC material 130. The LC layers are generally driven by control circuitry (not shown), for example, thin film transistors (TFTs) and associated electrical connections, disposed on the LC cell bottom 120. The control circuitry generally includes an array of thin film transistors (TFTs). In the case of OLCD (Organic LCD), where the TFTs are organic, the encapsulation layer 115 may be a thin film.

In the structure of FIG. 1a, a first polariser film or layer 110 is provided below the bottom encapsulation layer 115. A backlight layer 105 is provided below the first polariser film 110. The bottom encapsulation layer 115 could generally be a glass substrate. In the example of FIG. 1 which is an OLCD, the LC cell bottom 120 and LC cell top 140 are generally made of TAC (Cellulose Triacetate). The bottom encapsulation layer 115 may include an indium tin oxide (ITO) layer (not shown). The bottom encapsulation layer 115 and the first polariser film 110 generally form part of a driver component 76 of the display structure 100. The backlight layer 105 is generally a separate part from the display stack.

In the structure of FIG. 1a, a second polariser film 145 is provided on the top encapsulation layer 140. In one example, one side of the top encapsulation layer 140 there may be provided a colour filter layer (not shown); this may reside on the “LC cell top” layer 135. The encapsulation layer 140 may not be required if the “LC cell Top” is made of glass but in the case of an OLCD is generally present. The encapsulation film 140 could be integrated into the polariser 145 or “LC cell top” layer 135. The second polariser film 145, the top encapsulation layer 140 generally form part of a colour filter component 78 of the structure 100. The top encapsulation layer 140 is may be a glass substrate or may be a flexible organic-inorganic barrier, for example, in OLCDs.

FIG. 1b illustrates a schematic cross-sectional view of an example display stack 150 of an OLED (Organic Light Emitting Diode) display. The LCD display medium is replaced by OLED display medium 152 on substrate 154. The polariser is optional.

In each of FIGS. 1a and 1b the display and substrate(s) may be curved, for example fabricated from curved glass, or may be flexible, for example fabricated from plastic and employing organic TFTs. Details of suitable technology can be found on the Applicant's web site and in the Applicant's earlier published patent applications.

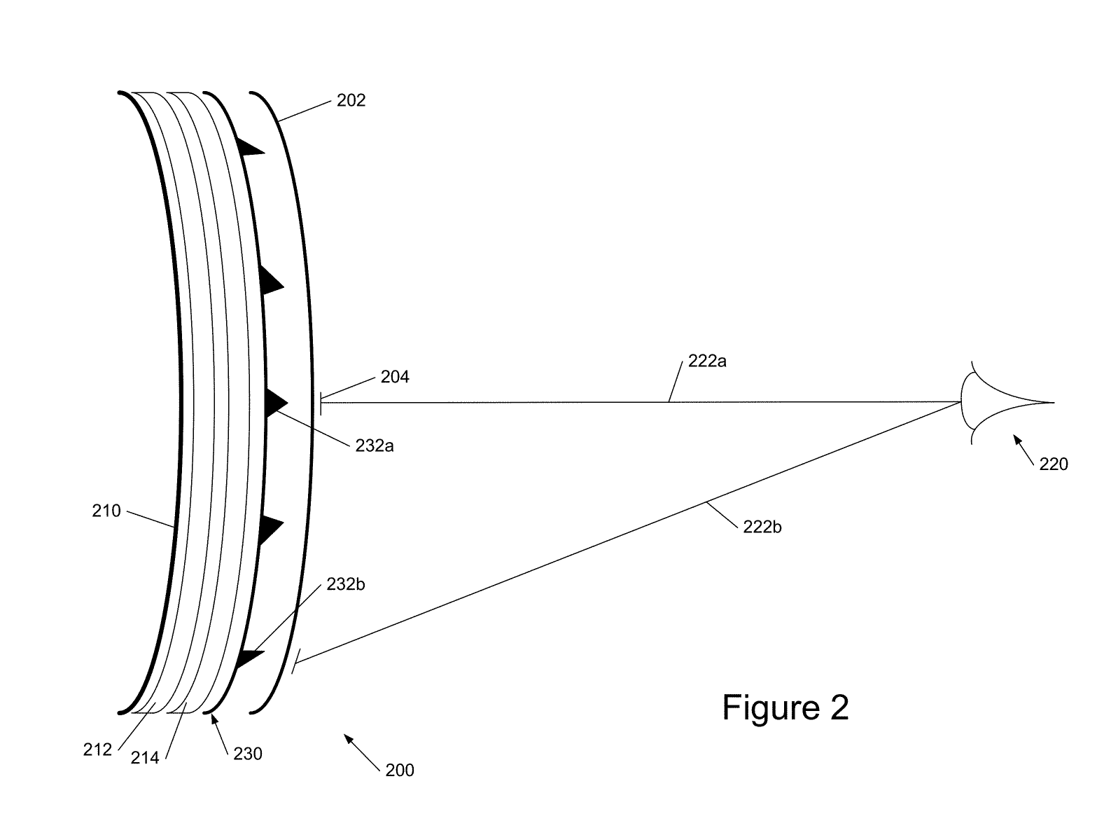

FIG. 2 shows a cross-sectional schematic view of a curved display 200 comprising a curved/flexible substrate 202 and having a plurality of display medium pixels 204. The display may comprise a display stack as previously described.

A viewer 220 sees different parts of the display from different angles with respect to the surface of the display because of the curvature of the display. For example as illustrated the viewer sees a central part of the display straight-on, that is with a viewing direction 222a at 90 degrees to the central part of the display. However the same viewer sees the edge of the display at an acute angle, that is viewing direction 222b makes an acute angle to the surface of the display at the edge of the display. It will be appreciated that in general the viewing angles differ even when the central part of the display is viewed obliquely rather than straight-on.

In the example of FIG. 2 the display is an LCD display. Thus the display includes a backlighting system comprising a backlight 212 with a back reflector 210 behind and a diffuser 214 in front. The backlight may be curved as illustrated and may comprise a waveguide, for example fabricated from PMMA.

A layer of brightness enhancing/privacy-protecting film 230 is provided between the backlight/diffuser and the display 202. In FIG. 2 the structures are shown with spaces between them but in practice they may abut or be partially or wholly integrally formed.

The brightness enhancing film 230 concentrates light from the backlight into a reduced range of angles, thereby increasing brightness and/or improving privacy by reducing the display viewing angle.

The film 230 is provided with a plurality of prisms 232 which preferentially direct the light into a reduced range of angles, for example by a process of refraction at the surfaces of the prisms and/or recycling of light attempting to exit in an undesired direction, for example by internal reflection or paths which exit one prism and re-enter an adjacent prism.

As illustrated schematically the prisms are progressively distorted across the surface of the film, to direct light preferentially along the viewing directions 222a,b taking into account the curvature of the display. Such a structure may be formed, for example, by embossing. Where the prisms define a regular array this may be slightly misaligned with an array defined by the pixels of the display, to avoid moire fringing patterns. For example lines of the prisms may be offset by a few degrees from lines of the pixels.

The film 230 may be located in front of the display rather than between the backlight and the display. In the example of FIG. 2 the display is an LCD display but the technique may also be applied, for example, to an OLED display, in which case the film is located between the display and the viewer.

Applications of the technology include, but are not limited to, in-vehicle displays, mobile phone/tablet displays, and ATM (Automated Teller Machine) displays.

No doubt many other effective alternatives will occur to the skilled person. It will be understood that the invention is not limited to the described embodiments and encompasses modifications apparent to those skilled in the art lying within the scope of the claims appended hereto.

1. A display for mounting on a curved surface for displaying information over a limited viewing angle, the display having a display stack comprising:
a substrate to conform to a curved surface;
a pixelated LCD display medium on the substrate;
a back light to illuminate the LCD display medium
a brightness enhancing film between the back light and the LCD display medium;
wherein the brightness enhancing film comprises a plurality of prisms to increase the brightness of light from the back light in a viewing direction,
wherein shapes of the prisms change with lateral position on the display i) to compensate for a change in viewing angle with lateral position on the display with respect to a curved surface of the display when the display is mounted on a curved surface and ii) such that light attempting to exit the prisms in directions other than the viewing direction is reflected by the prisms via total internal reflection and recycled by a recycling structure.

2. A display as claimed in claim 1, wherein said plurality of prisms define a regular array that is misaligned with an array defined by the pixels of the display.

3. A method of displaying information over a limited viewing angle using a curved display comprising a substrate bearing a pixelated LCD display medium, the method comprising:
providing a brightness enhancing film between a back light for the display and the LCD display medium of the display, the brightness enhancing film comprising a plurality of prisms to increase the brightness of light from the back light in a viewing direction,
gradually distorting shapes of the prisms with lateral position on the curved display i) to compensate for a change in viewing angle with respect to lateral position on the curved display and ii) such that light attempting to exit the prisms in directions other than the viewing direction is reflected by the prisms via total internal reflection and recycled by a recycling structure, whereby a viewing angle of the display is limited.

4. A method as claimed in claim 3, wherein said plurality of prisms define a regular array that is misaligned with an array defined by the pixels of the display.
